(19) United States
(12) Patent Application Publication
(10) Pub. No.: US 2023/0064344 A1
(43) Pub. Date: Mar. 2, 2023

(54) FLUOROSILICONE SURFACTANT, PREPARATION METHOD THEREFOR AND APPLICATION THEREOF

(71) Applicant: Corechem Corporation Holding Co., Ltd, Guangzhou (CN)

(72) Inventors: Xinchao WANG, Guangzhou (CN); Dawei XU, Guangzhou (CN); Fanwei MENG, Guangzhou (CN)

(73) Assignee: Corechem Corporation Holding Co., Ltd, Guangzhou (CN)

(21) Appl. No.: 17/777,632

(22) PCT Filed: Nov. 18, 2019
(86) PCT No.: PCT/CN2019/119089

§ 371 Date: Oct. 19, 2022

(51) Int. Cl. C08G 77/46; C09K 23/54; C08G 77/385

(52) U.S. Cl. CPC C08G 77/46; C09K 23/54; C08G 77/385

(57) ABSTRACT

A fluorosilicone surfactant, and a preparation method and a use thereof are provided. The preparation method of the fluorosilicone surfactant includes: mixing alkynol or a derivative thereof, an allylpolyether, and an alkenyl fluorine-containing monomer with hydrogen-containing silicone oil to allow a hydrosilylation reaction, where a structural formula of the hydrogen-containing silicone oil includes at least three Si—H bonds. The fluorosilicone surfactant prepared by the present disclosure has both excellent wettability and low-foaming performance.

### CROSS REFERENCE TO THE RELATED APPLICATIONS

This application is the national phase entry of International Application No. PCT/CN2019/119089, filed on Nov. 18, 2019, the entire contents of which are incorporated herein by reference.

### TECHNICAL FIELD

The present disclosure relates to the technical field of silicone, and in particular to a fluorosilicone surfactant, and a preparation method and a use thereof.

### BACKGROUND

At present, polyether-modified silicone wetting agents are widely used in the industries of water-borne coatings, inks, papermaking, and leather due to their excellent wettability. Compared with polyether (silicone-free) surfactants, such wetting agents can quickly wet a surface of a substrate to form a uniform coating film even when there are oil stains or even pores on the surface of the substrate.

At present, polyether-modified silicone wetting agents on the market are mainstream wetting agents widely used in the industries of coatings, inks, papermaking, and leather. However, the use of such wetting agents can be problematic because they may create too much foam or it may be difficult to eliminate foam during use. In order to eliminate foam, it is necessary to use a silicone antifoaming agent with strong antifoaming ability. However, after the antifoaming agent is added, defects often occur on a surface of a coating film under the combined action of the antifoaming agent and the wetting agent. In this way, it is necessary to increase an amount of the wetting agent to reduce a surface tension, and after the surface tension is reduced, it is difficult to eliminate foam. Therefore, the product composition becomes more and more complicated and induces more and more problems, which increases the product cost and reduces the product stability.

### SUMMARY

In view of the above problems, the present disclosure provides a low-foaming fluorosilicone surfactant with excellent wettability, and a preparation method and a use thereof.

In order to achieve the above objective, the present disclosure is implemented by the following technical solutions:

A preparation method of a fluorosilicone surfactant is provided, including: mixing alkynol or a derivative thereof, an allylpolyether, and an alkenyl fluorine-containing monomer with hydrogen-containing silicone oil to allow a hydrosilylation reaction, such that the alkynol or the derivative thereof, the allylpolyether, and the alkenyl fluorine-containing monomer are grafted to the hydrogen-containing silicone oil to obtain the fluorosilicone surfactant, where a structural formula of the hydrogen-containing silicone oil includes at least three Si—H bonds. Alkenyl in the alkenyl fluorine-containing monomer is selected from the group consisting of vinyl and propenyl. The alkenyl fluorine-containing monomer may be a monomer including alkenyl and fluorine. The alkynol may be hydrocarbyl alkynol. A multiple bond refers to a bond that can undergo a hydrosilylation reaction with a Si—H bond of the hydrogen-containing silicone oil, which can be a carbon-carbon double bond or a carbon-carbon triple bond.

The alkynol or the derivative thereof, the allylpolyether, and the alkenyl fluorine-containing monomer are mixed with the hydrogen-containing silicone oil to allow a hydrosilylation reaction, such that the alkynol or the derivative thereof, the allylpolyether, and the alkenyl fluorine-containing monomer are grafted to the hydrogen-containing silicone oil through the at least three Si—H bonds in the structural formula of the hydrogen-containing silicone oil.

After the hydrosilylation reaction, the product obtained has excellent wettability and low-foaming performance.

Since a hydrogen-containing silicone oil molecule includes at least three Si—H bonds, the following conditions may occur during the reaction: At least one Si—H bond in the hydrogen-containing silicone oil molecule undergoes a hydrosilylation reaction with an alkynol molecule or a derivative molecule thereof, such that the alkynol or derivative is grafted to the hydrogen-containing silicone oil molecule. At least one Si—H bond in the hydrogen-containing silicone oil molecule undergoes a hydrosilylation reaction with an allylpolyether molecule, such that the allylpolyether is also grafted to the hydrogen-containing silicone oil molecule. At least one Si-H bond in the hydrogen-containing silicone oil molecule undergoes a hydrosilylation reaction with an alkenyl fluorine-containing monomer, such that the alkenyl fluorine-containing monomer is also grafted to the hydrogen-containing silicone oil molecule.

As a further improvement, the preparation method may include: A mixture of the alkynol or the derivative thereof, the allylpolyether, and the alkenyl fluorine-containing monomer may be mixed with the hydrogen-containing silicone oil to allow a hydrosilylation reaction to obtain the fluorosilicone surfactant. Alternatively, a mixture of the alkynol or the derivative thereof and the allylpolyether may be mixed with the hydrogen-containing silicone oil to allow a hydrosilylation reaction to obtain an intermediate, and the intermediate may be mixed with the alkenyl fluorine-containing monomer to allow a hydrosilylation reaction to obtain the fluorosilicone surfactant. The molar ratio of multiple bonds in the alkynol or the derivative thereof, the allylpolyether, and the alkenyl fluorine-containing monomer to the Si—H bonds in the hydrogen-containing silicone oil is (0.9-1.1):1. The hydrogen-containing silicone oil has a hydrogen content of 0.2% to 1.5%.

As a further improvement, the alkynol may have a structural formula (a first general formula) of

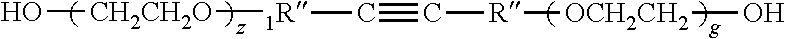

where z and g are each an integer, and 0≤z≤4 and 0≤g≤4; R″ is C₀-C₁₂ alkyl (which can be straight-chained or branched alkyl); ₁R″ is C₀-C₁₂ alkyl (which can be straight-chained or branched alkyl); and R″ and ₁R″ can be each preferably C₀-C₆ alkyl, which involves readily-available raw materials while ensuring low-foaming performance and excellent wettability;

the alkenyl fluorine-containing monomer may have a structural formula (a second general formula) of

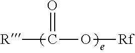

where R is C₂-C₁₂ hydrocarbyl; R′″ is selected from the group consisting of vinyl and propenyl; e is 0 or 1; and Rf is fluorine-substituted alkyl (fluoroalkyl), which can be perfluoroalkyl and polyfluoroalkyl (generally including 2 or more fluorine atoms);

the allylpolyether may have a structural formula (a third general formula) of

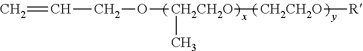

where x and y are each an integer, and 0≤x≤12 and 0≤y≤14; when one of x and y is 0, the other one is greater than 0; and R′ is any one selected from the group consisting of hydrogen, methyl, ethyl, and butyl; and

the hydrogen-containing silicone oil may have a structural formula (a fourth general formula) of

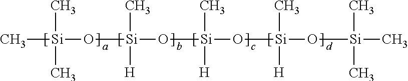

where a≥0; b+c+d≥3; a, b, c, and d are each an integer; and b, c, and d are each a positive integer.

As a further improvement, the preparation method may include: in the presence of a catalyst and a solvent, slowly adding a mixture of the alkynol or the derivative thereof, the allylpolyether, and the alkenyl fluorine-containing monomer to the hydrogen-containing silicone oil at 75° C. to 160° C. to allow a reaction for 2 h to 19 h.

As a further improvement, the preparation method may include: in the presence of a solvent and a catalyst, slowly adding a mixture of the alkynol or the derivative thereof and the allylpolyether to the hydrogen-containing silicone oil at 75° C. to 160° C. to allow a reaction for 2 h to 19 h to obtain an intermediate, and slowly adding the intermediate to the alkenyl fluorine-containing monomer at 75° C. to 160° C. to allow a reaction for 2 h to 19 h.

The slow addition mentioned here refers to addition at a speed that avoids the occurrence of gelatination as much as possible during the reaction and allows the reaction to proceed smoothly. For example, 150 g of the mixture of the alkynol or the derivative thereof, the allylpolyether, and the alkenyl fluorine-containing monomer may be added for 2 h to 3 h.

As a further improvement, the catalyst may be selected from the group consisting of a Karstedt's catalyst and chloroplatinic acid; and the solvent may be xylene.

The present disclosure also provides a fluorosilicone surfactant prepared by the preparation method described above.

As a further improvement, the fluorosilicone surfactant may have a structural formula (a fifth general formula) of

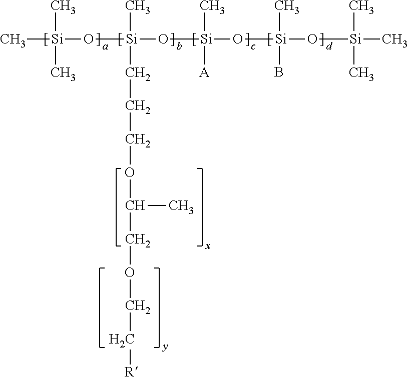

where

1) a≥0; b+c+d≥3; a, b, c, and d are each an integer; and b, c, and d are each a positive integer;

2) x and y are each an integer, and 0≤x≤12 and 0≤y≤14; when one of x and y is 0, the other one is greater than 0; and R′ is any one selected from the group consisting of hydrogen, methyl, ethyl, and butyl; and

3) A is

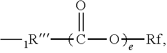

where Rf is fluorine-substituted alkyl; R is C₂-C₁₂ alkyl; e is 0 or 1; and ₁R′″ is ethyl or propyl, such as —CH₂—CH₂— or

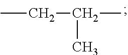

and

B is

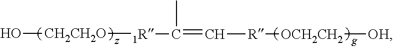

where z and g are each an integer, and 0≤z≤4 and 0≤g≤4; and ₁R″ and R″ are each C₀-C₁₂ alkyl (which can be straight-chained or branched alkyl).

The fluorosilicone surfactant prepared in the present disclosure can be well used as an anti-foaming wetting agent in a coating film.

Compared with the prior art, the present disclosure has the following beneficial effects:

In the present disclosure, alkynol or a derivative thereof, an allylpolyether, and an alkenyl fluorine-containing monomer are subjected to a hydrosilylation reaction with hydrogen-containing silicone oil whose structural formula includes at least three Si—H bonds to obtain a fluorosilicone surfactant, and the fluorosilicone surfactant has excellent low-foaming performance and wettability and can well meet the needs of use.

Since fluorine has a lower surface tension and a higher chemical stability than silicon, better wettability and stability can be provided. The alkynol or the derivative thereof can cooperate with the allylpolyether to provide a low dynamic surface with high compatibility. The grafting of the substances to the hydrogen-containing silicone oil can achieve both high wettability and low-foaming performance. With high compatibility, the surfactant can be widely used. In addition, the surfactant exhibits excellent hydrolysis resistance.

When used together with other ingredients, the surfactant leads to a simple ingredient formula due to low-foaming performance and high wettability, which can well meet the needs of use.

### DETAILED DESCRIPTION OF THE EMBODIMENTS

The present disclosure will be further described below in conjunction with specific examples.

It should be noted that, unless otherwise specified, the raw materials used in the technical solutions provided by the present disclosure are all prepared by conventional means or purchased from commercial sources.

A preparation method of a fluorosilicone surfactant is provided, including: mixing alkynol or a derivative thereof, an allylpolyether, and an alkenyl fluorine-containing monomer with hydrogen-containing silicone oil to allow a hydrosilylation reaction, such that the alkynol or the derivative thereof, the allylpolyether, and the alkenyl fluorine-containing monomer are grafted to the hydrogen-containing silicone oil to obtain the fluorosilicone surfactant. The structural formula of the hydrogen-containing silicone oil includes at least three Si—H bonds. Alkenyl in the alkenyl fluorine-containing monomer is selected from the group consisting of vinyl and propenyl.

Preferably, the preparation method of a fluorosilicone surfactant may include: mixing a mixture of the alkynol or the derivative thereof, the allylpolyether, and the alkenyl fluorine-containing monomer with the hydrogen-containing silicone oil to allow a hydrosilylation reaction to obtain the fluorosilicone surfactant; or mixing a mixture of the alkynol or the derivative thereof and the allylpolyether with the hydrogen-containing silicone oil to allow a hydrosilylation reaction to obtain an intermediate, and mixing the intermediate with the alkenyl fluorine-containing monomer to allow a hydrosilylation reaction to obtain the fluorosilicone surfactant. The molar ratio of multiple bonds in the alkynol or the derivative thereof, the allylpolyether, and the alkenyl fluorine-containing monomer to the Si—H bonds in the hydrogen-containing silicone oil is (0.9-1.1):1. The hydrogen-containing silicone oil has a hydrogen content of 0.2% to 1.5% and an average molecular weight of preferably 500 to 3,000. The molar ratio of the multiple bonds to the Si—H bonds in the hydrogen-containing silicone oil is (0.9-1.1):1, such that the reaction is complete and thorough.

Preferably, the preparation method of a fluorosilicone surfactant may include: in the presence of a catalyst and a solvent, slowly adding the mixture of the alkynol or the derivative thereof, the allylpolyether, and the alkenyl fluorine-containing monomer to the hydrogen-containing silicone oil at 75° C. to 160° C. to allow a reaction for 2 h to 19 h, preferably 3 h to 19 h, and most preferably 10 h to 19 h. The reaction time of 3 h to 19 h is favorable because the reaction is mostly likely complete.

Of course, after the reaction is completed, the solvent and unreacted monomer can be removed under vacuum.

In Examples 1 to 6, unless otherwise specified, a structural formula of the alkynol is the first general formula; a structural formula of the alkenyl fluorine-containing monomer is the second general formula; a structural formula of the allylpolyether is the third general formula; a structural formula of the hydrogen-containing silicone oil is the fourth general formula; and a structural formula of the fluorosilicone surfactant is the fifth general formula.

In Examples 1 to 6, the hydrogen content of the hydrogen-containing silicone oil refers to a mass percentage content of hydrogen from the silicon-hydrogen bonds of the hydrogen-containing silicone oil in the hydrogen-containing silicone oil.

In Examples 1 to 6, a molecular weight of the allylpolyether refers to an average molecular weight because there is a small amount of impurity in addition to the main part in the third general formula (values of x and y may be biased (values of x and y will float up and down in rare cases)). The molecular weight can be a molecular weight provided by a supplier of a product when the product is purchased. A molecular weight of the hydrogen-containing silicone oil also refers to an average molecular weight. A chloroplatinic acid solution is an aqueous chloroplatinic acid solution with a chloroplatinic acid content of 8%. ₁R″ is straight-chained or branched alkyl, and R″ is straight-chained or branched alkyl.

In the third general formula of the present disclosure, x and y refer to x and y of the main part.

### Example 1

1) 200 g of xylene was added to a four-necked flask and heated to reflux at 140° C. for 2 h to remove water.

2) A temperature in the four-necked flask was lowered to 75° C. 220 g (0.11 mol) of hydrogen-containing silicone oil (with a hydrogen content of 0.2% and an average molecular weight of 2,000) was added to the four-necked flask. A mixture of 130 g (0.20 mol) of an allylpolyether (the third general formula, where x was 0, y was about 14, and R′ was methyl, which had an average molecular weight of 650 and was also called allyl polyethylene glycol monomethyl ether), 40.2 g (0.12 mol) of alkynol (the first general formula, where z was 2, g was 2, ₁R″ was C₄ alkyl, and R″ was C₄ alkyl, which was also known as tetraethoxydecynediol and had a molecular weight of 346), 23.6 g (0.10 mol) of hexafluorobutyl acrylate (HFBA) (with a molecular weight of 236), and 0.0414 g of a chloroplatinic acid solution was evenly added dropwise for 12 h to the four-necked flask. The resulting reaction system was gradually heated to 100° C. and kept at 90° C. to 110° C. for 3 h. ₁R″ and R″ could both be —CH₂—CH₂—CH₂—CH₂—.

3) Then the reaction system was heated to 120° C. and kept at the temperature for 4 h, and then vacuum-pumping was conducted for 1 h at a vacuum degree of -0.09 or higher and a temperature of 100° C. to 120° C. to remove the solvent and unreacted monomer to obtain a sample 1.

The HFBA had a structural formula of

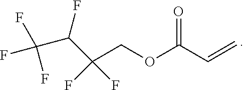

### Example 2

1) 200 g of xylene was added to a four-necked flask and heated to reflux at 140° C. for 2 h to remove water.

2) A temperature in the four-necked flask was lowered to 95° C. A mixture of 110 g (0.10 mol) of allyl polyethylene glycol polypropylene glycol monobutyl ether (the third general formula, where x was about 12, y was about 9, and R′ was butyl, which had an average molecular weight of 1,100), 28.4 g (0.25 mol) of hexynediol (the first general formula, where z and g were both 0, ₁R″ was —CH₂—CH₂—, and R″ was —CH₂—CH₂—, which had a molecular weight of 114), 30 g (0.10 mol) of octafluoropentyl acrylate (OFPA) (with a molecular weight of 286), and 0.0139 g of a Karstedt's catalyst was added to the four-necked flask. 110 g (0.07 mol) of hydrogen-containing silicone oil (with a hydrogen content of 0.4% and an average molecular weight of 1,500) was evenly added dropwise for 8 h to the four-necked flask. The resulting reaction system was gradually heated to 100° C. and kept at 90° C. to 110° C. for 3 h.

3) Then the reaction system was heated to 130° C. and kept at the temperature for 4 h, and then vacuum-pumping was conducted for 1 h at a vacuum degree of -0.09 or higher and a temperature of 100° C. to 130° C. to remove the solvent and unreacted monomer to obtain a sample 2.

The OFPA had a structural formula of

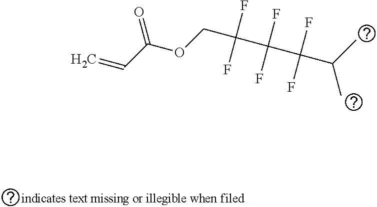 [SMILES: C=CC(=O)OCC(F)(F)C(F)(F)C(F)(F)C(C)C]

### Example 3

1) 200 g of xylene was added to a four-necked flask and heated to reflux at 140° C. for 2 h to remove water.

2) A temperature in the four-necked flask was lowered to 85° C., then 100 g (0.03 mol) of hydrogen-containing silicone oil (with a hydrogen content of 0.6% and an average molecular weight of 3,000) was added to the four-necked flask. A mixture of 170 g (0.20 mol) of an allylpolyether (the second general formula, where x was about 8, y was about 8, and R′ was hydrogen, which had a molecular weight of 850), 78.6 g (0.30 mol) of tetraethoxybutynediol (the first general formula, where ₁R″ was —CH₂—, R″ was —CH₂—, and z and g were both 2, which had a molecular weight of 262), 43.2 g (0.10 mol) of perfluorooctyl methacrylate (PFOMA) (with a molecular weight of 432), and 0.0784 g of a chloroplatinic acid solution was evenly added dropwise for 12 h to the four-necked flask. The resulting reaction system was gradually heated to 145° C. and kept at 140° C. to 150° C. for 3 h.

The PFOMA had a structural formula of

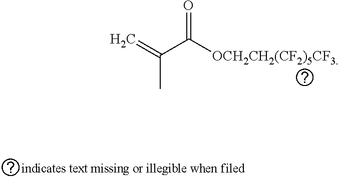

3) Then vacuum-pumping was conducted for 1 h at a vacuum degree of -0.09 or higher and a temperature of 140° C. to 150° C. to remove the solvent and unreacted monomer to obtain a sample 3.

### Example 4

1) 200 g of xylene was added to a four-necked flask and heated to reflux at 140° C. for 2 h to remove water.

2) A temperature in the four-necked flask was lowered to 105° C., then a mixture of 105 g (0.30 mol) of allyl polyethylene glycol butyl ether (the third general formula, where x was 0, y was about 5 or 6, and R′ was butyl, which had an average molecular weight of 350), 425.4 g (0.77 mol) of octaethoxydodecynediol (the first general formula, where ₁R″ was C₅ alkyl, R″ was C₅ alkyl, and z and g were both 4, which had a molecular weight of 550), 64.8 g (0.15 mol) of PFOMA (with a molecular weight of 432), and 0.0705 g of a chloroplatinic acid solution was added to the four-necked flask. 137.5 g (0.14 mol) of hydrogen-containing silicone oil (with an average molecular weight of 1,000 and a hydrogen content of 0.8%) was evenly added dropwise for 8 h. The resulting reaction system was gradually heated to 150° C. and kept at 150° C. to 160° C. for 3 h. ₁R″ and R″ could be both —CH₂CH₂CH₂CH₂CH₂—.

3) Then vacuum-pumping was conducted for 30 min at a vacuum degree of −0.09 or higher and a temperature of 150° C. to 160° C. to remove the solvent and unreacted monomer to obtain a sample 4.

### Example 5

1) 200 g of xylene was added to a four-necked flask, and heated to reflux at 140° C. for 2 h to remove water.

2) A temperature in the four-necked flask was lowered to 115° C., then 100.0 g (0.20 mol) of hydrogen-containing silicone oil (with a hydrogen content of 1.0% and a molecular weight of 500) was added to the four-necked flask. A mixture of 75.0 g (0.10 mol) of allyl polypropylene glycol monomethyl ether (the third general formula, where x was about 12, y was 0, and R′ was methyl, which had a molecular weight of about 750), 161.6 g (0.80 mol) of diethoxyhexynediol (the first general formula, ₁R″ was —CH₂—CH₂—, R″ was —CH₂—CH₂—, and z and g were both 1, which had a molecular weight of 202), 30.8 g (0.20 mol) of trifluoroethyl acrylate (TFEA) (with a molecular weight of 154), and 0.0367 g of a chloroplatinic acid solution was evenly added dropwise for 6 h to the four-necked flask. The resulting reaction system was gradually heated to 130° C. and kept at 120° C. to 140° C. for 3 h. The TFEA had a structural formula of

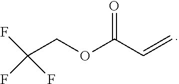

3) Then vacuum-pumping was conducted for 1 h at a vacuum degree of -0.09 or higher and a temperature of 120° C. to 140° C. to remove the solvent and unreacted monomer to obtain a sample 5.

### Example 6

1) 200 g of xylene was added to a four-necked flask and heated to reflux at 140° C. for 2 h to remove water.

2) A temperature in the four-necked flask was lowered to 75° C. 80 g (0.11 mol) of hydrogen-containing silicone oil (with a hydrogen content of 1.5% and an average molecular weight of 750) was added to the four-necked flask. A mixture of 120 g (0.30 mol) of ally! polyethylene glycol monobutyl ether (the third general formula, where y was 6 or 7 and R′ was butyl, which had an average molecular weight of 400), 120 g (0.75 mol) of diethoxypropynediol (the first general formula, where ₁R″ was —CH₂—, R″ was absent or was —CH₂—, ₁R″ was absent, and z and g were both 1, which had a molecular weight of 160), 60.6 g (0.18 mol) of tridecafluoro-1-octene (with a molecular weight of 346), and 0.0381 g of a Karstedt's catalyst was evenly added dropwise for 6 h to the four-necked flask. The resulting reaction system was gradually heated to 100° C. and kept at 90° C. to 110° C. for 6 h. The tridecafluoro- 1-octene had a CAS number of 25291-17-2 and a structural formula of CF₃(CF₂)₅CH=CH₂.

3) Then vacuum-pumping was conducted for 1 h at a vacuum degree of -0.09 or higher and a temperature of 120° C. to 140° C. to remove the solvent and unreacted monomer to obtain a sample 6.

The preparation methods of a fluorosilicone surfactant in Examples 1 to 6 can also be as follows: in the presence of a solvent and a catalyst, a mixture of alkynol or a derivative thereof and an allylpolyether is slowly added to hydrogen-containing silicone oil at 75° C. to 160° C. to allow a reaction for 2 h to 19 h (preferably 3 h to 19 h) to obtain an intermediate. The intermediate is slowly added to an alkenyl fluorine-containing monomer at 75° C. to 160° C. to allow a reaction for 2 h to 19 h (preferably 3 h to 19 h).

For example, in Example 4, the preparation method could be as follows:

1) 200 g of xylene was added to a four-necked flask and heated to reflux at 140° C. for 2 h to remove water.

2) A temperature in the four-necked flask was lowered to 105° C. A mixture of 105 g (0.30 mol) of ally! polyethylene glycol butyl ether (the third general formula, where x was 0, y was about 5 or 6, and R′ was butyl, which had an average molecular weight of 350), 425.4 g (0.77 mol) of octaethoxydodecynediol (the first general formula, where ₁R″ was C₅ alkyl, R″ was C₅ alkyl, and z and g were both 4, which had a molecular weight of 550), and 0.0705 g of a chloroplatinic acid solution was added to the four-necked flask, 137.5 g (0.14 mol) of hydrogen-containing silicone oil (with an average molecular weight of 1,000 and a hydrogen content of 0.8%) was evenly added dropwise for 8 h. The resulting reaction system was gradually heated to 150° C. and kept at 150° C. to 160° C. for 2 h to 11 h to obtain an intermediate. The system was cooled to 105° C., and 64.8 g (0.15 mol) of PFOMA (with a molecular weight of 432) was evenly added dropwise for 8 h to the four-necked flask. The resulting reaction system was gradually heated to 150° C. and kept at 150° C. to 160° C. for 2 h to 11 h.

3) Then vacuum-pumping was conducted for 30 min at a vacuum degree of -0.09 or higher and a temperature of 150° C. to 160° C. to remove the solvent and unreacted monomer to obtain a sample 4.

For example, in Example 6, the preparation method could be as follows:

1) 200 g of xylene was added to a four-necked flask and heated to reflux at 140° C. for 2 h to remove water.

2) A temperature in the four-necked flask was lowered to 75° C. 80 g (0.11 mol) of hydrogen-containing silicone oil (with a hydrogen content of 1.5% and an average molecular weight of 750) was added to the four-necked flask. A mixture of 120 g (0.30 mol) of allyl polyethylene glycol monobutyl ether (the third general formula, where y was about 6 or 7 and R′ was butyl, which had an average molecular weight of 400), 120 g (0.75 mol) of diethoxypropynediol (the first general formula, where ₁R″ was —CH₂—, R″ was absent or was —CH₂—, ₁R″ was absent, and z and g were both 1, which had a molecular weight of 160), and 0.0381 g of a Karstedt's catalyst was evenly added dropwise for 6 h to the four-necked flask. The resulting reaction system was gradually heated to 100° C. and kept at 90° C. to 110° C. for 6 h to obtain an intermediate. The system was cooled to 75° C., and 60.6 g (0.18 mol) of tridecafluoro-1-octene (with a molecular weight of 346) was evenly added dropwise for 6 h to the four-necked flask. The resulting reaction system was gradually heated to 100° C. and kept at 90° C. to 110° C. for 6 h.

3) Then vacuum-pumping was conducted for 1 h at a vacuum degree of -0.09 or higher and a temperature of 120° C. to 140° C. to remove the solvent and unreacted monomer to obtain a sample 6.

### Result Test

### Comparative Test

Step 1) 10 containers were taken, and 85 g of water-based acrylic resin (trade brand: DSM; and model: Neocryl XK14) and 15 g of deionized water were added to each container.

Step 2) 10 samples that were each of 0.3 g were taken and respectively added to the containers.

Step 3) Materials in each container were thoroughly mixed and allowed to stand for 2 h, and then the anti-foaming ability, wettability, appearance, and leveling property were tested.

The 10 samples were respectively: six products prepared in Examples 1 to 6 (product 1, product 2, product 3, product 4, product 5, and product 6) and four typical wetting agent products on the market (commodity 1, commodity 2, commodity 3, and commodity 4). The four typical products on the market were all commercially-available polyether-modified silicones.

The liquid samples in the containers were respectively liquid sample 1 (the product 1 was added), liquid sample 2 (the product 2 was added), liquid sample 3 (the product 3 was added), liquid sample 4 (the product 4 was added), liquid sample 5 (the product 5 was added), liquid sample 6 (the product 6 was added), liquid sample 7 (the commodity 1 was added), liquid sample 8 (the commodity 2 was added), liquid sample 9 (the commodity 3 was added), and liquid sample 10 (the commodity 4 was added).

### Anti-Foaming Ability Test

The liquid samples 1 to 10 in the containers were each shaken for 10 min on a shaker and then respectively poured into 10 graduated bottles (which were cylindrical and had a volume of 100 mL and a height of 6 cm). An initial foam height was recorded, and then a foam height was recorded at 2 h and 24 h. Experimental results were shown in Table 1.

TABLE 1

| | Liquid | Liquid | Liquid | Liquid | Liquid | Liquid | Liquid | Liquid | Liquid | Liquid |
|---|---|---|---|---|---|---|---|---|---|---|
| | sample | sample | sample | sample | sample | sample | sample | sample | sample | sample 1 |
| Sample | 1 | 2 | 3 | 4 | 5 | 6 | 7 | 8 | 9 | 0 |
| Initial foam h | 75 | 65 | 60 | 70 | 68 | 80 | 100 | 90 | 85 | 95 |
| eight | | | | | | | | | | |
| (mm) | | | | | | | | | | |
| 2 h | 55 | 58 | 55 | 50 | 50 | 58 | 80 | 85 | 70 | 65 |
| (mm) | | | | | | | | | | |
| 24 h | 52 | 53 | 50 | 50 | 50 | 51 | 58 | 55 | 53 | 52 |
| (mm) | | | | | | | | | | |

The data in Table 1 shows that the fluorosilicone surfactant prepared by the present disclosure is low-foam forming and is much superior to products on the market in this aspect. The initial foam height and the foam height at 2 h of the fluorosilicone surfactant are significantly lower than that of the commercial wetting agents on the market, indicating that the product prepared by the present disclosure is low-foam forming.

### Static Surface Tension Test

A ring-type static surface tensiometer (model: SFZL-A1, product number: 20170501003) was used to test a surface tension. The smaller the reading, the lower the surface tension. Experimental results were shown in Table 2.

TABLE 2

| | | | | | | | | | | Liquid |
|---|---|---|---|---|---|---|---|---|---|---|
| | Liquid s | Liquid s | Liquid s | Liquid s | Liquid s | Liquid s | Liquid s | Liquid s | Liquid s | sample |
| Sample | ample 1 | ample 2 | ample 3 | ample 4 | ample 5 | ample 6 | ample 7 | ample 8 | ample 9 | 10 |
| Static | 32.5 | 31.3 | 31.0 | 32.2 | 32.8 | 32.4 | 32.9 | 33.8 | 32.4 | 33.7 |
| surface | | | | | | | | | | |
| tension | | | | | | | | | | |
| (mN/m) | | | | | | | | | | |

The data in Table 1 shows that the fluorosilicone surfactant prepared by the present disclosure has a very low surface tension and high wettability, which can meet market needs. Most of the samples have a lower surface tension than the products on the market, which can well meet the needs.

### Compatibility, Gloss, and State (Edge Shrinking) of Coating Films

1. Fabrication of a scraper: Each sample was coated on a flat plate and pressed with a film maker (which was a hollow object with left and right sides and a top surface). The film maker was pulled up to obtain a coating film with a thickness of 100 pm. After the coating film was dried, various properties of the coating film (which was a dry film) were measured. A process of fabricating a dry film is also called a scraper fabrication process.

The state of the dry film was observed, the compatibility was determined, and then the gloss was measured. Experimental results are shown in Table 3. Compatibility determination criteria: The permeability of a coating film was classified into levels 1 to 5, where level 5 represented the highest permeability and level 1 represented the lowest permeability. The gloss was measured by a specular gloss meter with an incident angle of 60°. The higher the gloss, the better the compatibility of the coating film. The smaller the shrinkage width, the better the wettability of the coating film.

TABLE 3

| | Liquid | Liquid | Liquid | Liquid | Liquid | Liquid | Liquid | Liquid | Liquid | Liquid |
|---|---|---|---|---|---|---|---|---|---|---|
| | sample | sample | sample 3 | sample | sample | sample | sample | sample | sample | sample |
| | 1 | 2 | | 4 | 5 | 6 | 7 | 8 | 9 | 10 |
| Permeability | 4 | 4 | 4 | 5 | 5 | 5 | 5 | 4 | 5 | 4 |
| (level) | | | | | | | | | | |
| Shrinkage | 2 | 2 | 2 | 1 | 0 | 1 | 4 | 3 | 2 | 3 |
| width | | | | | | | | | | |
| (mm) | | | | | | | | | | |
| Gloss | 85 | 86 | 84 | 88 | 85 | 87 | 82 | 80 | 84 | 83 |
| (degree) | | | | | | | | | | |

It can be seen from Table 3 that the samples of the present disclosure all have excellent compatibility and wettability.

2. Two parts were taken from each of the liquid samples 1 to 10, and an antifoaming agent BYK022 was added to each part, such that a mass fraction of the antifoaming agent BYK022 in one part was 0.2% (which was recorded as liquid sample 1#) and a mass fraction of BYK022 in the other part was 0.4% (which was recorded as liquid sample 2#). Liquid samples 1# and 2#190 were each used to fabricate a scraper, and the anti-shrinkage ability of the wetting agent was observed. The more the number of shrinkage cavities on the coating film, the worse the wettability of the wetting agent. Experimental results are shown in Table 4.

TABLE 4

| | Liquid | Liquid | Liquid | Liquid | Liquid | Liquid | Liquid | Liquid | Liquid | Liquid |
|---|---|---|---|---|---|---|---|---|---|---|
| Sample | sample 1 | sample 2 | sample 3 | sample 4 | sample 5 | sample 6 | sample 7 | sample 8 | sample 9 | sample 10 |
| Liquid | 0 | 0 | 0 | 0 | 0 | 0 | 2 | 1 | 2 | 3 |
| sample 1 | | | | | | | | | | |
| # | | | | | | | | | | |
| Liquid | 2 | 0 | 2 | 0 | 0 | 1 | 7 | 6 | 3 | 5 |
| sample 2 | | | | | | | | | | |
| # | | | | | | | | | | |

It can be seen from Table 4 that, after the antifoaming agent is added, the products in Examples 1 to 6 of the present disclosure exhibit a significantly better anti-shrinkage ability than the wetting agents on the market, indicating that the products in Examples 1 to 6 have excellent wettability and are obviously superior to the products on the market. In the presence of the antifoaming agent, the products of the present disclosure still exhibit prominent anti-shrinkage ability, that is, prominent wettability, and thus exhibit strong destruction resistance, which can well resist the interference of other components.

It should be noted that C₀ in the present disclosure refers to no carbon.

The allylpolyether in the present disclosure can be purchased from Nantong Chenrun Chemical Co., Ltd. or Hangzhou Danwei Technology Co., Ltd., and can also be purchased from other companies.

The technical solutions provided by the examples of the present disclosure are described in detail above, and the principles and implementations of the examples of the present disclosure are described herein by using specific examples. The description of the above examples is provided merely to help explain the principles of the examples of the present disclosure. In addition, those of ordinary skill in the art can make changes to the specific implementations and applications according to the examples of the present disclosure. In conclusion, the content of this specification should not be construed as limiting the present disclosure.

What is claimed is:

1. A preparation method of a fluorosilicone surfactant, comprising:
mixing alkynol or a derivative the alkynol, an allylpolyether, and an alkenyl fluorine-containing monomer with a hydrogen-containing silicone oil to allow a hydrosilylation reaction, wherein the alkynol or the derivative the alkynol, the allylpolyether, and the alkenyl fluorine-containing monomer are grafted to the hydrogen-containing silicone oil to obtain the fluorosilicone surfactant, wherein a structural formula of the hydrogen-containing silicone oil comprises at least three Si—H bonds; and alkenyl in the alkenyl fluorine-containing monomer is selected from the group consisting of vinyl and propenyl.

2. The preparation method of the fluorosilicone surfactant according to claim 1, comprising: mixing a mixture of the alkynol or the derivative the alkynol, the allylpolyether, and the alkenyl fluorine-containing monomer with the hydrogen-containing silicone oil to allow the hydrosilylation reaction to obtain the fluorosilicone surfactant; or mixing a mixture of the alkynol or the derivative of the alkynol and the allylpolyether with the hydrogen-containing silicone oil to allow the hydrosilylation reaction to obtain an intermediate, and mixing the intermediate with the alkenyl fluorine-containing monomer to allow the hydrosilylation reaction to obtain the fluorosilicone surfactant, wherein a molar ratio of multiple bonds in the alkynol or the derivative the alkynol, the allylpolyether, and the alkenyl fluorine-containing monomer to the at least three Si—H bonds in the hydrogen-containing silicone oil is (0.9-1.1):1.

3. The preparation method of the fluorosilicone surfactant according to claim 1, wherein the hydrogen-containing silicone oil has a hydrogen content of 0.2% to 1.5% and an average molecular weight of 500 to 3,000.

4. The preparation method of the fluorosilicone surfactant according to claim 1, wherein
the alkynol has a structural formula of 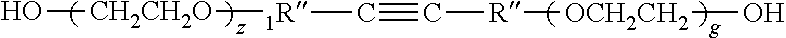
wherein z and g are each an integer, and 0≤z≤4 and 0≤g≤4; R″ is C₀-C₁₂ alkyl; and ₁R″ is C₀-C₁₂ alkyl;
the alkenyl fluorine-containing monomer has a structural formula of 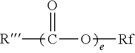
wherein R is C₂-C₁₂ alkyl; R′″ is selected from the group consisting of vinyl and propenyl; e is 0 or 1; and Rf is fluorine-substituted alkyl;
the allylpolyether has a structural formula of 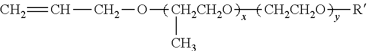
wherein x and y are each an integer, and 0≤x≤12 and 0≤y≤14; when one of x and y is 0, the other one of x and y is greater than 0; and R′ is one selected from the group consisting of hydrogen, methyl, ethyl, and butyl; and
the hydrogen-containing silicone oil has a structural formula of 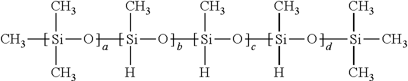
wherein a≥0; b+c+d≥3; a, b, c, and d are each an integer; and b, c, and d are each a positive integer.

5. The preparation method of the fluorosilicone surfactant according to claim 1, comprising: in the presence of a catalyst and a solvent, slowly adding a mixture of the alkynol or the derivative the alkynol, the allylpolyether, and the alkenyl fluorine-containing monomer to the hydrogen-containing silicone oil at 75° C. to 160° C. to allow the hydrosilylation reaction for 2 h to 19 h.

6. The preparation method of the fluorosilicone surfactant according to claim 1, comprising: in the presence of a solvent and a catalyst, slowly adding a mixture of the alkynol or the derivative the alkynol and the allylpolyether to the hydrogen-containing silicone oil at 75° C. to 160° C. to allow the hydrosilylation reaction for 2 h to 19 h to obtain an intermediate, and slowly adding the intermediate to the alkenyl fluorine-containing monomer at 75° C. to 160° C. to allow the hydrosilylation reaction for 2 h to 19 h.

7. The preparation method of the fluorosilicone surfactant according to claim 5, wherein the catalyst is selected from the group consisting of a Karstedt's catalyst and chloroplatinic acid; and the solvent is xylene.

8. A fluorosilicone surfactant prepared by the preparation method according to claim 1.

9. The fluorosilicone surfactant according to claim 8, wherein the fluorosilicone surfactant has a structural formula of 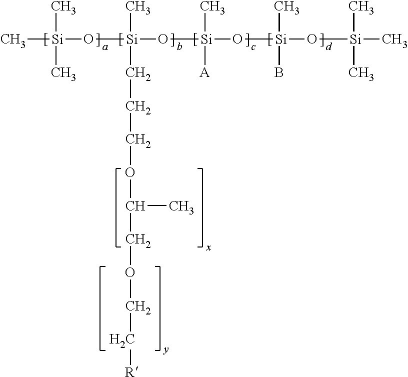
wherein 1) a≥0; b+c +d≥3; a, b, c, and d are each an integer; and b, c, and d are each a positive integer;
2) x and y are each an integer, and 0≤x≤12 and 0≤y≤14; when one of x and y is 0, the other one of x and y is greater than 0; and R′ is aw_{y}—one selected from the group consisting of hydrogen, methyl, ethyl, and butyl; and

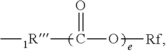

3. A is wherein Rf is fluorine-substituted alkyl; R is C₂-C₁₂ alkyl; e is 0 or 1; and ₁R′″ is ethyl or propyl; and
B is 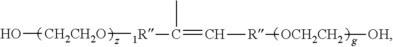
wherein z and g are each an integer, and 0≤≤4 and
0≤g≤4; and ₁R″ and R″ are each C₀-C₁₂ alkyl.

10. A method of use of the fluorosilicone surfactant according to claim 8 as an anti-foaming wetting agent in a coating film.

11. The preparation method of the fluorosilicone surfactant according to claim 6, wherein the catalyst is selected from the group consisting of a Karstedt's catalyst and chloroplatinic acid; and the solvent is xylene.

12. The fluorosilicone surfactant according to claim 8, wherein the preparation method of the fluorosilicone surfactant comprises: mixing a mixture of the alkynol or the derivative of the alkynol, the allylpolyether, and the alkenyl fluorine-containing monomer with the hydrogen-containing silicone oil to allow the hydrosilylation reaction to obtain the fluorosilicone surfactant; or mixing a mixture of the alkynol or the derivative of the alkynol and the allylpolyether with the hydrogen-containing silicone oil to allow the hydrosilylation reaction to obtain an intermediate, and mixing the intermediate with the alkenyl fluorine-containing monomer to allow the hydrosilylation reaction to obtain the fluorosilicone surfactant, wherein a molar ratio of multiple bonds in the alkynol or the derivative of the alkynol, the allylpolyether, and the alkenyl fluorine-containing monomer to the at least three Si—H bonds in the hydrogen-containing silicone oil is (0.9-1.1):1.

13. The fluorosilicone surfactant according to claim 8, wherein the hydrogen-containing silicone oil used in a preparation of the fluorosilicone surfactant has a hydrogen content of 0.2% to 1.5% and an average molecular weight of 500 to 3,000.

14. The fluorosilicone surfactant according to claim 8, wherein in a preparation of the fluorosilicone surfactant,
the alkynol has a structural formula of 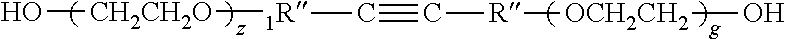
wherein z and g are each an integer, and 0≤z≤4 and 0≤g≤4; R″ is C₀-C₁₂ alkyl; and ₁R″ is C₀-C₁₂ alkyl;
the alkenyl fluorine-containing monomer has a structural formula of 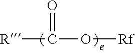
wherein R is C₂-C₁₂ alkyl; R′″ is selected from the group consisting of vinyl and propenyl; e is 0 or 1; and Rf is fluorine-substituted alkyl;
the allylpolyether has a structural formula of 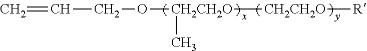
wherein x and y are each an integer, and 0<x<12 and 0<y<14; when one of x and y is 0, the other one of x and y is greater than 0; and R′ is one selected from the group consisting of hydrogen, methyl, ethyl, and butyl; and
the hydrogen-containing silicone oil has a structural formula of 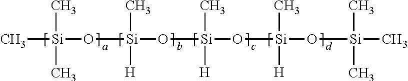
wherein a≥0; b+c+d≥3; a, b, c, and d are each an integer; and b, c, and d are each a positive integer.

15. The fluorosilicone surfactant according to claim 8, wherein the preparation method of the fluorosilicone surfactant comprises: in the presence of a catalyst and a solvent, slowly adding a mixture of the alkynol or the derivative of the alkynol, the allylpolyether, and the alkenyl fluorine-containing monomer to the hydrogen-containing silicone oil at 75° C. to 160° C. to allow the hydrosilylation reaction for 2 h to 19 h.

16. The fluorosilicone surfactant according to claim 8, wherein the preparation method of the fluorosilicone surfactant comprises: in the presence of a solvent and a catalyst, slowly adding a mixture of the alkynol or the derivative of the alkynol and the allylpolyether to the hydrogen-containing silicone oil at 75° C. to 160° C. to allow the hydrosilylation reaction for 2 h to 19 h to obtain an intermediate, and slowly adding the intermediate to the alkenyl fluorine-containing monomer at 75° C. to 160° C. to allow the hydrosilylation reaction for 2 h to 19 h.

17. The fluorosilicone surfactant according to claim 15, wherein the catalyst is selected from the group consisting of a Karstedt's catalyst and chloroplatinic acid; and the solvent is xylene.
